(19) United States
(12) Patent Application Publication
(10) Pub. No.: US 2026/0045619 A1
(43) Pub. Date: Feb. 12, 2026

(54) Battery compartment cover

(71) Applicant: Water When LLC, Bend, OR (US)

(72) Inventors: Romain ROUX, Vancouver (CA); Varda TREIBACH-HECK, Bend, OR (US)

(73) Assignee: Water When LLC, Bend, OR (US)

(21) Appl. No.: 19/289,017

(22) Filed: Aug. 2, 2025

Related U.S. Application Data
(60) Provisional application No. 63/680,449, filed on Aug. 7, 2024.

(51) Int. Cl. H01M 50/262; E05C 5/02; H01M 50/213

(52) U.S. Cl. CPC H01M 50/262; E05C 5/02; H01M 50/213

(57) ABSTRACT

A door to cover a battery compartment of a device has, at a hinged end, a hinge pin that is retained within a slot in a guide member that is provided at an outer peripheral edge of a battery compartment of the device. At a latch end, a hook portion has an opening that, when the door is closed, captures at least one latch pin that is adjacent to the outer peripheral edge of the battery compartment. When the door is open, the hook portion is clear of the latch pin, such that the door may rotate about the hinge pin. The slot permits both lateral and rotational movement of the door such that the door may be opened and closed by a user sliding the door laterally. The door may be securely closed independent of any need for a secondary latching arrangement.

### REFERENCE TO RELATED APPLICATIONS

This application claims priority of U.S. provisional patent application 63/680,449, filed 7 Aug. 2024.

### TECHNICAL FIELD

This invention relates to covers and doors that can be opened and closed for battery compartments.

### BACKGROUND OF THE INVENTION

Countless devices, nowadays, of course, run on replaceable batteries. Most commonly, the batteries (such as AAA, AA, C and D) are substantially cylindrical. In some cases, batteries are “laid” into a battery compartment, substantially “laterally”. In these arrangements, there is usually a coiled or flat spring element against which the electrically negative contact surface of the battery is pushed, and then the other end of the battery—with the positive contact—is pushed into place within a compartment. A cover can then be slid, snapped or even screwed into place to fit the batteries snugly and securely into the compartment and protect the components of the host device and ensure its proper functioning.

In other arrangements, the batteries are installed “lengthwise”, such that each battery is inserted into the compartment end-first until the usually (but not necessarily) negative metal cap is in contact with a spring contact. A door or cover is then closed and locked into position, which also pushes the batteries (usually their negative polarity metal caps) against the respective spring contacts. Contacts on the inside of the door then push against the (usually) positive metal caps of the batteries to complete the electrical connection. Insertion alignment is crucial for the proper functioning of a device.

Battery covers are not easy for users to close properly. Sometimes, as with camera batteries, this is because they require separate actions such as sliding a locking button or switch to secure the door in place. Sometimes, locking of the door depends on applying enough force to cause some latching mechanism to engage. Usually this involves the user pushing the door inward hard enough that a spring-biased pin or tongue can align with and enter a corresponding hole or slot. One problem with such solutions is that the locking mechanism can easily unlock if the door is bumped, and this then often leads to the need for an additional locking mechanism. These secondary locking mechanisms are often tiny, which makes them prone to damage, require high-precision manufacturing, and are difficult to maneuver for users whose fingertips are relatively big, or who don't have long enough fingernails.

Many other devices that need battery compartment covers, such as television and fan remote controls, suffer from over-engineering: They are designed with such concern for vibration resistance and protection against even other types of inadvertent opening by users that it becomes difficult to open the compartment covers at all. What is needed in this respect is a door solution that is vibration-resistant and secure yet easy to operate

Another problem with many existing battery compartment doors is that they require two hands to either close or open the door, or both. For example, those with secondary latching mechanisms mentioned above, but also many others, require the user to hold the device steadily with one hand while maneuvering the cover with the other.

What is needed is a battery compartment door that prioritizes the user experience by being easy to operate for people with hands of all different sizes, requiring minimal joint flexibility or manual dexterity, and that is secure against accidental opening without requiring additional locking mechanisms.

Known arrangements for battery compartment covers are often unsuitable when the device cannot easily be lifted or tipped, either to access the battery compartment at all, or to tip out and change the batteries. For example, consider a device that forms a platform on which an object is placed, but is either not easy to move, or should not be moved at all. If the battery door is on the underside of the device, such as is common in, for example, scales to weigh objects, then clearly the object on top would have to be removed. If the battery compartment is on the top of the device, however, then it may be subject to damage from the object itself, or it will be at a higher risk of water intrusion if the object contains water, such as a container for a potted plant. Especially (but not exclusively) in such cases, what is needed is an arrangement for a battery compartment cover that allows easy access when changing batteries, and that does not require lifting or tipping of the device to do so.

### BRIEF DESCRIPTION OF THE DRAWINGS

FIG. 1 depicts a device with a battery compartment cover or door closed, according to one embodiment.

FIG. 2 depicts the device with the battery compartment cover or door open.

FIG. 3 is a front view of the device with the battery compartment cover or door closed.

FIGS. 4 and 5 illustrate how the battery compartment door is slid into position to be opened.

FIG. 6 is a front view of the interior of the battery compartment of the device.

FIG. 7 is a perspective view of the battery compartment cover or door and of some structures in the battery compartment that enable it to shift and lock.

FIG. 8 shows the battery compartment door from above, as well as one part of a locking arrangement.

FIGS. 9-12 illustrate the positions of the battery compartment cover or door as it moves from the opened to the closed position.

In FIGS. 4-12, portions of the device are cut away so as to make it easier to see and focus on the structures relating directly to the invention.

FIG. 13 is an enlarged view of a hook portion of the battery compartment door.

### DETAILED DESCRIPTION

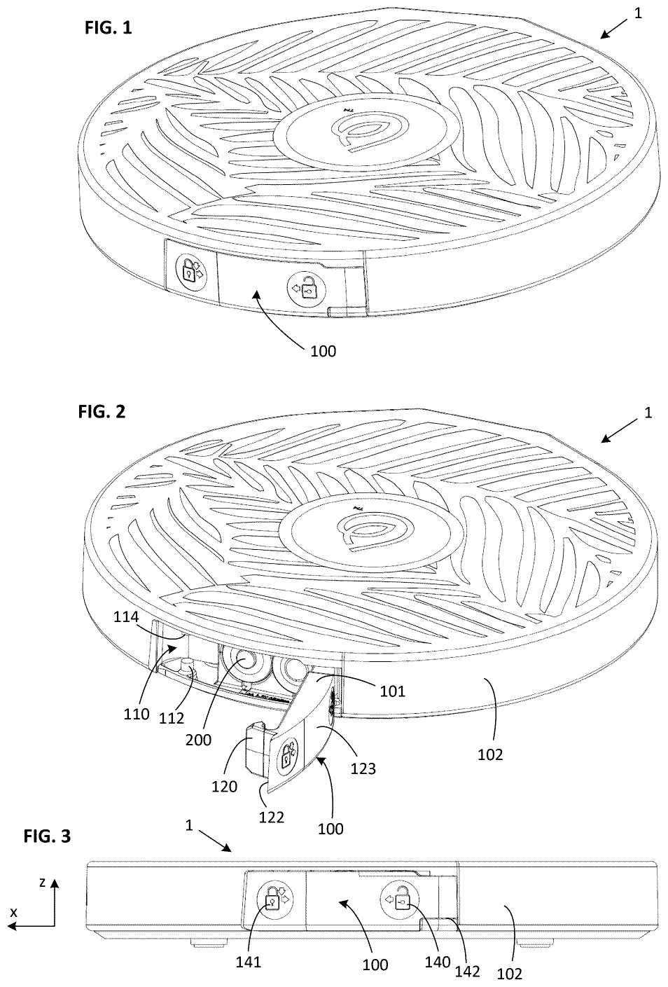

In general, embodiments of the invention provide a convenient cover or door 100 to close over a battery compartment of a device 1. For purposes of this invention, the terms “door” and “cover” are synonymous. In the figures, the device 1 is shown as being substantially disc-shaped, that is, cylindrical, having a circular periphery, with flat or substantially flat top and bottom surfaces, and with a height much less than its diameter. This is because one prototype of the battery compartment door 100 involved a platform on which a potted plant could be set. This is only one of many possible shapes and functions of the device 1, however, which is shown as it is, by way of example, only. The periphery of the device shown in the figures is therefore curved. This illustrates one advantage of embodiments of the invention, namely, that it may be used with such surfaces as well as those that are planar. As FIG. 1 illustrates, the battery compartment door 100 can maintain the continuity of even a flush, curved peripheral surface at the edge of the device 1.

Arranging the door 100 on the periphery of the device, that is, on the “edge”, makes the arrangement well suited for devices on which objects are set and should not be or are not convenient to move. The platform for potted plants is one of many examples. There is thus no need to lift the object off the device to access the battery compartment. As will be understood from the description below, there is also no need to tip the device to remove the batteries, which may pop out under the force of inner spring contacts.

FIG. 2 shows the embodiment of FIG. 1, but with the battery compartment door 100 open, revealing one or more batteries 200 and a recessed opening or well 110 into which a hook portion 120 at a latch end of the door 100 can fit when the door is closed and the hook portion 120 hooks around a pair of vertically extending, opposing latch pins 112, 114. As can be seen, in this embodiment, the door 100 tapers from a hinged portion 101 that is hinged in the device (see below) to a thinner or even fully tapered tip portion 122, with the door gradually becoming thicker in between; this allows the outer surface 123 of the door to conform to and be flush or almost flush with the rest of the periphery of the device 1. For reference, the end of the door that includes the hook portion may be referred to as the “latch end”, whereas the opposite end, about which the door rotates, may be referred to as the “hinged end”.

See FIG. 12. When the door is closed, the inner surface of the edge portion 122 may rest against a ledge 300. The very tip of the edge portion 122 may extend beyond the ledge 300 to make it easy for the user to put a fingertip or fingernail under the tip and pull the door open. Note that this may not be necessary in devices in which the door will tend to pop open on its own under the force of the spring contacts of the batteries but would allow the door to be easily pulled open even in devices that don't have battery contact springs that bias the door open on their own. In most devices, these spring contacts will be in the interior of the battery compartment, and thus not visible in the figures, but may also be arranged in the door itself. It would also be possible to form the edge portion 122 with the tip lying flush against the periphery of the platform 100. It would, similarly, be possible to form the hinged end of the door arrangement such that it is flush against the outer surface 102 of the device 1. As shown in FIGS. 8 and 12, the outer surface of the ledge 300 and the inner surface of the tip 122 of the door extend laterally and align with the slot 127. Especially if the slot curves, however, the ledge 300 may be omitted so that the tip 122 may sit flush against the outer surface 102 of the device 1.

As FIG. 3 shows, markings 140, 141 are preferably provided on the outer surface of the battery compartment door 100 to indicate to the user which motions the user should make to open and close the door, and where on the door the user should preferably press to do so. The markings are, therefore, preferably located at the appropriate places on the door. Just for the sake of convenient reference, an x-z coordinate system is shown in FIG. 3 to indicate lateral and vertical directions, respectively.

One advantage of embodiments of the invention is that it is easy to open and close the door 100 with one hand or even (if the device is fastened or held down, for example, by the weight of an object placed on it), with only one finger or one's thumb - there are no small parts, such as secondary latching mechanisms, that the user must maneuver. The invention can therefore also be easily used by those with relatively large hands or lower dexterity.

To make it easier to slide the door and prevent a finger from sliding off, its outer surface may be provided with one or more grooved, textured or otherwise non-smooth areas to provide more friction. It would also be possible to have a vertical ridge that extends outward from the door surface to make it easier for the user's finger to push against to slide the door, or a groove or indentation deep enough for the user's fingernail or fingertip to fit in and make it easier to apply lateral force to the door.

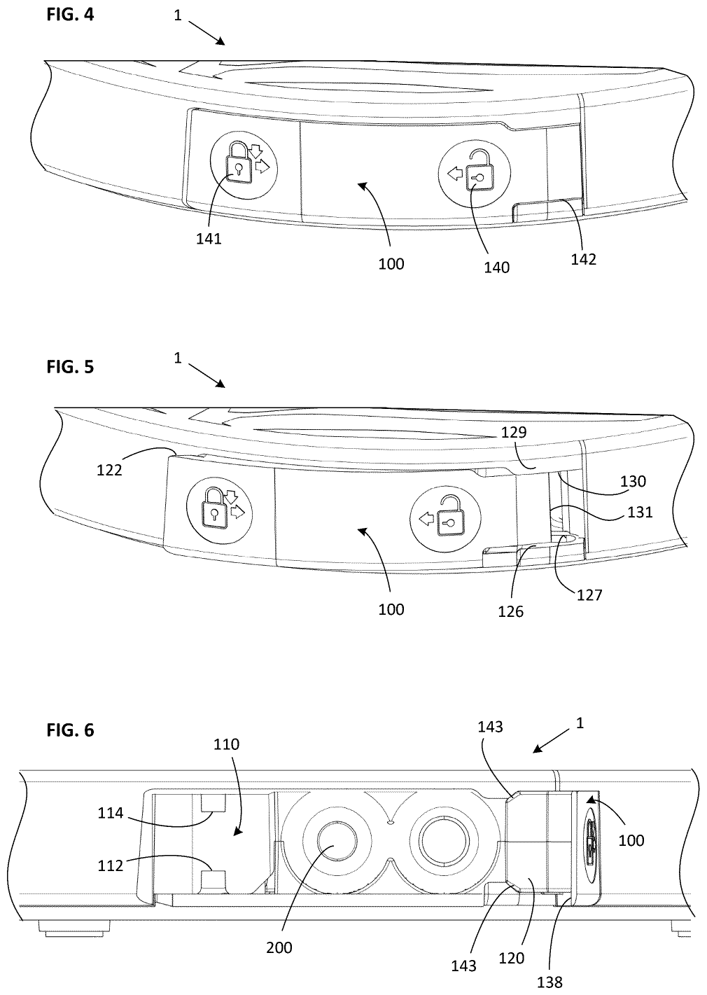

As depicted in FIG. 3, to open the door the user will slide the door 100 to the left; for example, the user may simply press a finger against the door and slide it to the left. To close it, the user will press in and then slide the door to the right. Of course, the directions left and right will depend on how the door is mounted, and may be reversed depending on where the door is slidably hinged. FIG. 4 is a perspective view of the door in the closed position, showing the same features as FIG. 3. FIG. 4 is also the first in a series of illustrations of how the battery compartment door 100 is opened.

See FIG. 5. Assume now that the user has pressed against the door 100, preferably at the position of marking 140, and slid the door to the left. A slot 127 is provided in a lower guiding member 126. A corresponding upper slot 130 in an upper guiding member 129 may also be provided with the same general structure so as to restrict the hinged inner portion of the door to lateral (x-axis) and rotational movement (about the z-axis). As FIG. 5 illustrates, the guiding members are part of or attached to lower and upper surfaces of the battery compartment, adjacent to its outer edge. When the door 100 is slid to the left, the outer portion of the door, corresponding in width to the distance the inner hinge portion has moved in the slots 127, 130, will extend over the outer surface of the device 1.

FIG. 6 more clearly shows the pins 112 that the hook portion 120 of the door will engage when the door is closed and secured. Having separate pins 112, 114 is easier to manufacture, but it would also be possible to arrange a single pin instead, which extends from the same bottom and top surfaces of the battery compartment 110 as the separate pins.

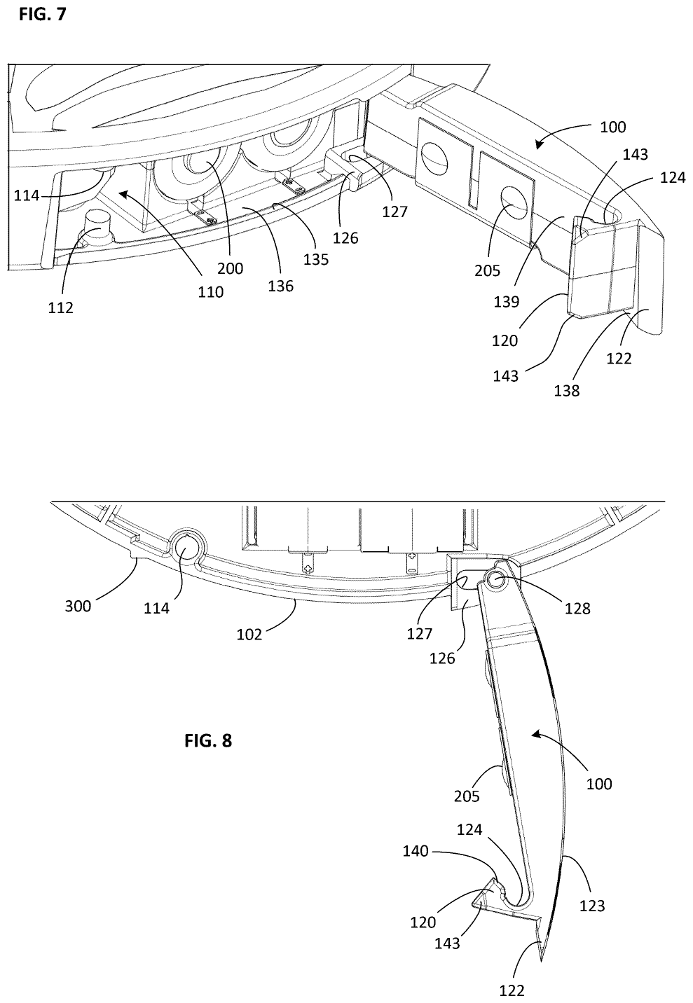

As FIG. 7 shows, the guiding member 126 (the corresponding upper one is not visible in this perspective view but may have the same structure) may extend over a lip or ridge portion 135 of the bottom surface 136 of the battery compartment 110. The lip portion 135 may then be recessed inwards by a distance corresponding to the thickness of the bottom edge 138 of the door. When the door is closed, its outer surface will therefore be flush with the outer peripheral surface of the device.

The hook portion 120 of the battery compartment door 100 has an opening 124 corresponding to the shape and diameter of the pins 112, 114 so that the hook portion securely captures the latch pin(s) 112, 114.

An electrical contact member 205 is preferably provided on the inner wall 139 of the door 100. Depending on how it is configured, one or both of the contact members may also act as a spring member, although, in most implementations, as in many if not most devices, there will be springs located in the interior of the battery well. When the door is closed, this contact member will come into contact with the corresponding terminals of the battery/-ies. These springs eliminate the need for extra parts because they serve a double function: (1) ensuring proper contact resistance between the batteries and electronics so that the battery energy gets efficiently used and is not wasted as when sub-optimal contact is made and (2) ensuring that the door remains securely latched without wobbling and also to help prevent accidental openings by maintaining outward biasing force on the door so that the latch pins 112, 114 remain firmly captured within the opening 124.

In the illustrated embodiment, the inner terminals of the batteries maybe be formed as springs (not shown), as in prior art arrangements described above. As the door closes, it will therefore push the batteries against the springs, thereby also providing an outward biasing force on the door that helps not only to hold it securely, without wobbling, but also to cause the door to open outward when it first reaches the open position when the hook portion 120 clears the latch pin(s) 112, 114. If more than one battery is provided (for example, two are illustrated), and they are connected in series, the contact 205 will connect the positive terminal of one of the batteries and the negative terminal of the other. Any known arrangement may then be provided for the inner contact terminals, such as one coil spring for the inner negative battery terminal and a flat spring for the positive terminal of the other battery, such as the contact 205.

As FIG. 8 illustrates, the inner, hinged end 131 (see FIG. 5) of the door 100 (viewed as when the door is open) is configured as a slidable hinge, in which a vertically extending hinge pin 128 is captured in and can also slide laterally in the slot 127 (with a similar structure above). The slot 127 should be at most as wide as the diameter of the pin 128 or at most slightly wider so as to retain the lower end of the pin 128, and thus the inner end 131 of the door securely against movement in the radial direction (for round platforms) or “inward” and “outward” motion (for platform shapes in general) but still allow easy sliding of the pin 128 within the slot and rotation of the door 100 when it has reached a position to do so, when the hook portion 124 is moving outward from the pins 112, 114. In other words, whereas a conventional hinge joint enables only one degree of freedom (rotation), the hinge arrangement in embodiments of the invention allow for two - both rotation of the door relative to the rest of the device, and also lateral movement, constrained by the slot 127 so that it cannot slide laterally totally out of the guide member, but far enough that the hook portion can latch around the pins 112, 114. In the figures, the slot 127 is shown as extending laterally, that is, in the x-direction (FIG. 3). This makes it easiest to slide the door laterally, but it would also be possible for the slot to be curved to be concentric with the outer surface 102 of the device if this is curved; when the device is substantially cylindrical, as in the figures, the slot will therefore correspond to a radial arc of the device. Even in these cases, the slot extends laterally.

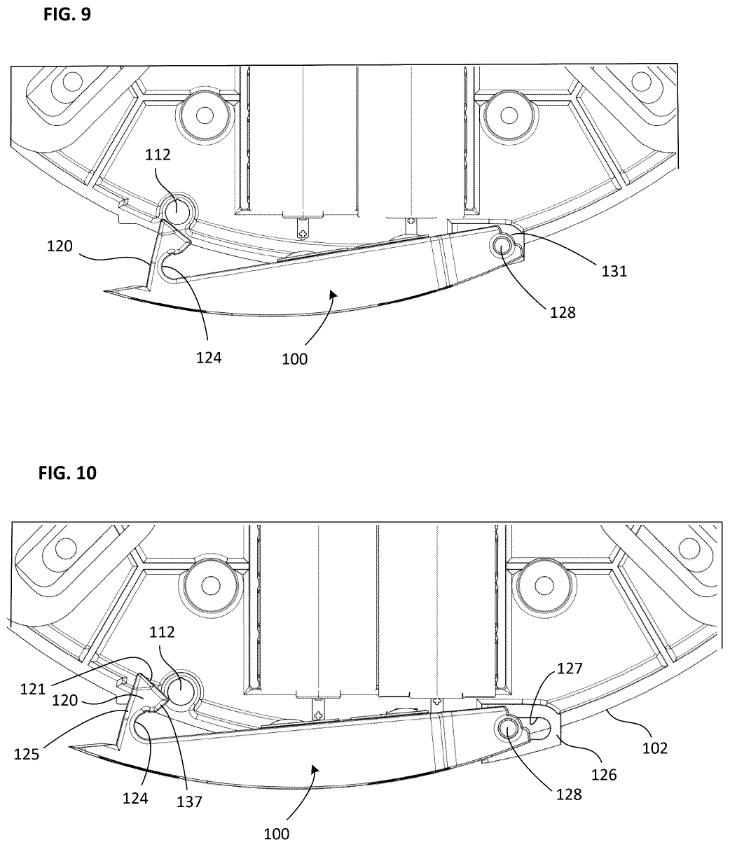

FIGS. 8-12 illustrate how the door is closed. Starting from the open position shown in FIG. 8, the user pushes the door 100 so that it rotates about the hinge pin 128. Unless the user has also slid the door laterally, the hook portion 120 of the door will contact the pins 112, 114, as depicted in FIG. 9. (Viewed from above, as in FIGS. 8-12, pin 112 will lie below and be obscured by pin 114.) As FIGS. 6-8 illustrate, the corners of the hook portion 120 of the door are preferably provided with a bevel 143. This additional feature helps the door close more easily and properly while allowing for looser assembly tolerances; otherwise, with tight tolerances required, the door is more likely to catch on the top or bottom of the opening of the battery compartment during closing if the manufacturing or assembly tolerance is even slightly off.

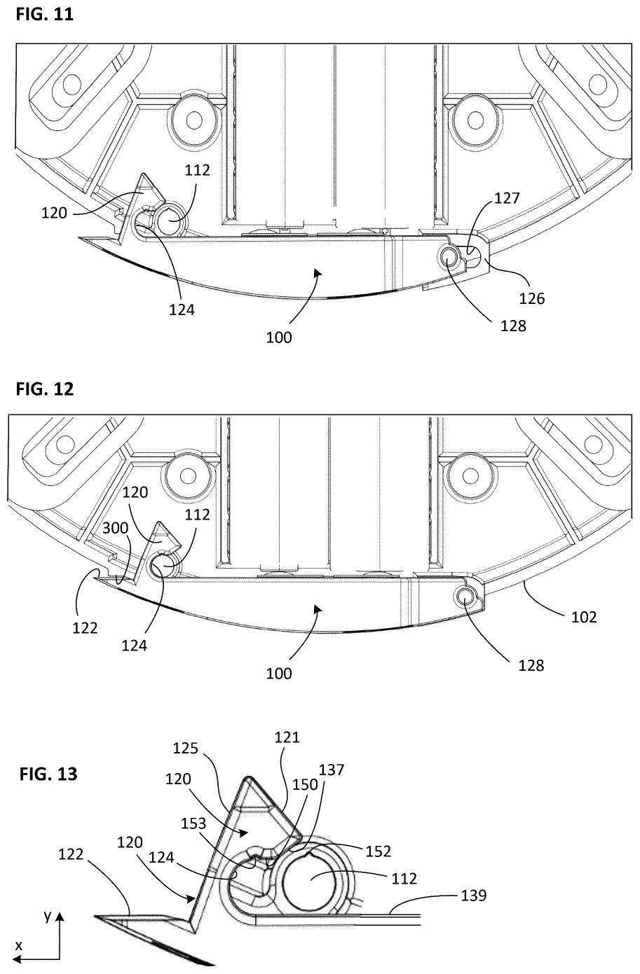

The user then slides the door laterally until the hook portion 120 clears the pins 112, 114 (FIG. 10 to FIG. 11), and then presses the door inward until the pins 112, 114 align with the opening 124. An inner edge 121 of the hook portion 120 is preferably at an acute angle relative to the outermost edge 125 to help urge the door laterally so that the hook portion more easily clears the pins 114. The As FIG. 10 shows, a hooking edge 137 of the hook portion adjacent to the opening 124 is preferably at an acute angle to the inner edge 121, and angled towards the opening so as to help guide the hook portion into the correct position around the pins when the user presses inward.

Although not required, the absence of such a guiding feature could cause the user to press the door closed with excessive force which may then cause the pins 112, 114 to break off or some other part of the mechanism to be damaged. The user then slides the door laterally to the right (viewed as in the figures) until the hook portion fully engages the pins 112, 114 (FIG. 12), which then are captured within the opening 124. Note that the opening is deep enough and preferably extends more than 180 degrees around the circumference of the pins so that, when the pins are fully captured in it, the hook portion cannot be pulled out and away from the pins. Without such secure closure, the batteries may lose proper electrical contact with the contact springs which may cause the device to lose power or otherwise malfunction.

See FIGS. 12 and 13. The ability of the hook portion 120 to securely capture the pin(s) 112, 114 and prevent the door 100 from opening without user action can be increased in different ways. In some cases, it will suffice for the opening to extend circumferentially more than 180 degrees around the pin(s) 112, 114. The door 100, and thus the hook portion 120, is preferably made of a mostly rigid but at least slightly flexible plastic, such that, when the user slides the door laterally to close it, the hook portion will then flex enough to allow the pin(s) 112, 114 to seat in the opening, whereupon at least a small portion of the hook portion will “close” and prevent the pin(s) from sliding out without the user applying a lateral force.

As one alternative, a small transition surface 150 may be provided between the hooking edge 137 and the opening of the opening. This surface 150 may be made parallel to the inner wall 139 of the door, such that the width of the opening between the surface 150 and the wall 139 is less than the diameter of the door, but by no more than the hook portion can bend open without damage or permanent deformation. The pin(s) are then held in place not only by friction, but by the hook portion closing on them when they are seated in the opening 124.

FIG. 13 shows yet another alternative for securing the door in place in the closed position. In this embodiment, each pin 112, 114, is provided with a protrusion 152, which, when the pin is seated within the opening, fits—snaps—naps—into a corresponding indentation 153 in the opening when the user slides the door laterally (to the right as shown in FIGS. 12 and 13). In the figures, the protrusion is a ridge that extends vertically, parallel to the central axis of the pin(s) 112, 114 and the indentation is a corresponding groove. Again, the plastic material of the hook portion will flex enough to allow the protrusion to pass within the opening before the hook portion can positively grip the pin(s) 112, 114.

To ensure proper holding effect, the groove is preferably arranged on a line that is perpendicular to the inner door surface 139, that is, perpendicular to the direction in which the door slides to close. As such, the groove and ridge could be formed 180 degrees around relatively to how they are shown in FIGS. 12 and 13. Instead of a ridge and groove, it would also be possible to form the protrusion as an outward extending “dot” or “button” that fits into a corresponding “dimple” on the inner surface of the opening, although, in most cases, this will be more difficult to manufacture and will require greater precision.

In addition to positively securing the hook portion and thus door 100 in the closed position, the protrusion/indentation feature has an additional advantage: the “click” when the protrusion snaps into the indentation will also provide the user an audible and/or tactile indication that the door is properly closed.

In some embodiments, additional alignment features are included on the lower edge of the door that guide the door closed while preventing it from getting stuck on the upper or lower edges of the main body. These features are also advantageous to allow for manufacturing and assembly micro errors that could cause the hinge gap 142 (FIG. 4) between the door and the main body (FIGS. 3 and 4) to be too wide. This may in turn cause the door body to “sag” and get caught on edges of the device's main body as the door gets pushes towards the closed position.

To open the door, the user simply performs the motions depicted in FIGS. 8-12, but in reverse order and direction. Note, however, that, to lock the door, the user will also need to press the door inward before sliding it into the locking position. To unlock the door, however, the user will need only to slide the door to the left (viewed as in the figures) enough for the hook portion 120 to clear the pins 112, 114 laterally, since the outward spring force of the battery contacts will push the door open.

1. A door to cover a battery compartment of a device, said door comprising:
at a hinged end, a hinge pin that is retained within a laterally extending slot in a guide member that is provided at an outer peripheral edge of a battery compartment of the device;
at a latch end, a hook portion having an opening that,
when the door is in a closed position, securely captures at least one latch pin that is secured in the battery compartment adjacent to the outer peripheral edge of the battery compartment;
when the door is in an open position, the hook portion is clear of the latch pin, such that the door may rotate about the hinge pin;
whereby
the slot permits both lateral and rotational movement of the door;
the door may be moved from the closed to the open position, and vice versa, by a user sliding the door laterally; and
the door may be securely closed independent of any need for a secondary latching arrangement.

2. The door of claim 1, in which the door is biased to open by at least one battery contact configured as a spring member.

3. The door of claim 1, in which an inner edge of the hook portion is at an acute angle relative to an outermost edge and urges the door laterally in a direction so to help guide the hook portion to clear the latch pin when the user presses the door inward.

4. The door of claim 1, further comprising a hooking edge of the hook portion that is located between the opening and the inner edge and is at an acute angle to the inner edge, so as to guide the latch pin into the opening when the user slides the door laterally into the closed position.

5. The door of claim 1, in which:
the device is substantially cylindrical, with a height less than its radius, such that the device has a substantially circular periphery; and
the door, when closed, is substantially flush with a peripheral surface of the device.

6. The door of claim 1, in which the slot is curved to correspond to a radial arc of the device.

7. The door of claim 1, in which the at least one latch pin is provided with a protrusion which, when the door is in the closed position, fits into a corresponding indentation in the opening.

8. A door to cover a battery compartment of a device, said door comprising:
at a hinged end, a hinge pin that is retained within a laterally extending slot in a guide member that is provided at an outer peripheral edge of a battery compartment of the device;
at a latch end, a hook portion having an opening that,
when the door is in a closed position, securely captures at least one latch pin that is secured in the battery compartment adjacent to the outer peripheral edge of the battery compartment;
when the door is in an open position, the hook portion is clear of the latch pin, such that the door may rotate about the hinge pin;
in which:
the door is biased to open by at least one battery contact configured as a spring member;
an inner edge of the hook portion is at an acute angle relative to an outermost edge and urges the door laterally in a direction so to help guide the hook portion to clear the latch pin when a user presses the door inward;
a hooking edge of the hook portion that is located between the opening and the inner edge and is at an acute angle to the inner edge, so as to guide the latch pin into the opening when the user slides the door laterally into the closed position;
the at least one latch pin is provided with a protrusion which, when the door is in the closed position, fits into a corresponding indentation in the opening;
the device is substantially cylindrical, with a height less than its radius, such that the device has a substantially circular periphery; and
the door, when closed, is substantially flush with a peripheral surface of the device;
whereby:
the slot permits both lateral and rotational movement of the door;
the door may be moved from the closed to the open position, and vice versa, by the user sliding the door laterally; and
the door may be securely closed independent of any need for a secondary latching arrangement.
